(19) United States
(12) Patent Application Publication
(10) Pub. No.: US 2009/0153705 A1
(43) Pub. Date: Jun. 18, 2009

(54) IMAGE-CAPTURING ELEMENT AND IMAGE-CAPTURING APPARATUS

(75) Inventors: Yasutoshi KATSUDA, Osaka (JP); Shinichi Fujii, Osaka (JP); Genta Yagyu, Hyogo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/271,334

(22) Filed: Nov. 14, 2008

(30) Foreign Application Priority Data
Dec. 18, 2007 (JP) 2007-326110

(51) Int. Cl. H04N 5/335

(52) U.S. Cl. 348/273; 348/E05.091

(57) ABSTRACT

An image-capturing element includes a group of first pixels configured to receive object light and generate an image signal representing an object image; and a group of second pixels configured to receive the object light and generate a ranging signal for detecting a phase difference. The second pixels each include an optical filter on a light-receiving side thereof. The optical filter allows visible light in a wavelength range wider than a wavelength range of visible light that is allowed by a green primary-color filter to be transmitted therethrough within the object light to be transmitted therethrough.

### CROSS REFERENCES TO RELATED APPLICATIONS

The present invention contains subject matter related to Japanese Patent Application JP 2007-326110 filed in the Japanese Patent Office on Dec. 18, 2007, the entire contents of which are incorporated herein by reference.

### BACKGROUND OF THE INVENTION

### Field of the Invention

The present invention relates to an image-capturing element having a focus detection function and to a technology related to the image-capturing element.

A technology in which a focus detection function using a phase-difference detection method is incorporated in an image-capturing element (solid-state image-capturing element) exists.

For example, in Japanese Unexamined Patent Application Publication No. 2005-303409, in an image-capturing element in which ordinary pixels of R (red), G (green), and B (blue) for image capturing are arranged in Bayer pattern, at least one sequence among G pixels arranged in one oblique sequence is formed as an AF pixel sequence for focus detection using a phase-difference detection method.

### SUMMARY OF THE INVENTION

However, in the above-described image-capturing element of the related art, a G color filter is arranged on the light-receiving surface of an AF pixel. As a consequence, in a case where much light of a color other than G is contained in object light, the object light is reduced by the G color filter, and focus detection accuracy is decreased.

Accordingly, it is desirable to provide a technology capable of performing focus detection with high accuracy by using an image-capturing element having a focus detection function by using a phase-difference detection method.

According to an embodiment of the present invention, there is provided an image-capturing element including: a group of first pixels configured to receive object light and generate an image signal representing an object image; and a group of second pixels configured to receive the object light and generate a ranging signal for detecting a phase difference, wherein the second pixels each include an optical filter on a light-receiving side thereof, and wherein the optical filter allows visible light in a wavelength range wider than a wavelength range of visible light that is allowed by a green primary-color filter to be transmitted therethrough within the object light to be transmitted therethrough.

According to another embodiment of the present invention, there is provided an image-capturing element including: a group of first pixels configured to receive object light and generate an image signal representing an object image; and a group of second pixels configured to receive the object light and generate a ranging signal for detecting a phase difference, wherein the second pixels each include an optical filter on a light-receiving side thereof, and wherein the optical filter causes visible light in an infrared range within the object light to not be transmitted therethrough.

According to another embodiment of the present invention, there is provided an image-capturing apparatus including: an image-capturing element having a group of first pixels configured to receive object light and generate an image signal representing an object image and a group of second pixels configured to receive the object light and generate a ranging signal for detecting a phase difference; image obtaining means for obtaining a captured image on the basis of the image signal; and focus detection means for performing focus detection on the basis of the ranging signal, wherein the second pixels each include an optical filter on a light-receiving side thereof, and wherein the optical filter causes visible light in a wavelength range wider than a wavelength range of visible light that is allowed by a green primary-color filter to be transmitted therethrough within the object light to be transmitted therethrough.

According to another embodiment of the present invention, there is provided an image-capturing apparatus including: an image-capturing element having a group of first pixels configured to receive object light and generate an image signal of an object image and a group of second pixels configured to receive the object light and generate a ranging signal for detecting a phase difference; image obtaining means for obtaining a captured image on the basis of the image signal; and focus detection means for performing focus detection on the basis of the ranging signal, wherein the second pixels each include an optical filter on a light-receiving side thereof, and wherein the optical filter causes visible light within the object light to not be transmitted therethrough.

According to the embodiments of the present invention, an optical filter for allowing visual light in a wavelength range wider than a wavelength range of visual light that is allowed by a green primary-color filter to be transmitted therethrough within the object light to be transmitted therethrough is arranged on the light-receiving side of the second pixel for detecting a phase difference. Therefore, it is possible to perform focus detection with high accuracy.

### BRIEF DESCRIPTION OF THE DRAWINGS

FIG. 1 shows the exterior configuration of an image-capturing apparatus according to a first embodiment of the present invention;

FIG. 2 shows the exterior configuration of the image-capturing apparatus according to the first embodiment of the present invention;

FIG. 3 is a longitudinal sectional view of the image-capturing apparatus;

FIG. 4 is a longitudinal sectional view of the image-capturing apparatus;

FIG. 5 is a block diagram showing the electrical configuration of the image-capturing apparatus;

FIG. 6 illustrates the configuration of an image-capturing element;

FIG. 7 illustrates the configuration of the image-capturing element;

FIG. 8 is a longitudinal sectional view of an AF pixel;

FIG. 9 shows pixel output of an AF line;

FIG. 10 shows the shift amount and the defocus amount of pixel output;

FIG. 11 shows the transmittance of an optical filter according to the first embodiment of the present invention;

FIG. 12 shows the transmission ratio of white light of each primary-color transmission filter of RGB;

FIG. 13 shows the transmittance of an optical filter according to a second embodiment of the present invention; and

FIG. 14 shows the transmittance of an optical filter according to a modification.

### DESCRIPTION OF THE PREFERRED EMBODIMENTS

### First Embodiment

### Exterior Configuration of Image-Capturing Apparatus 1A

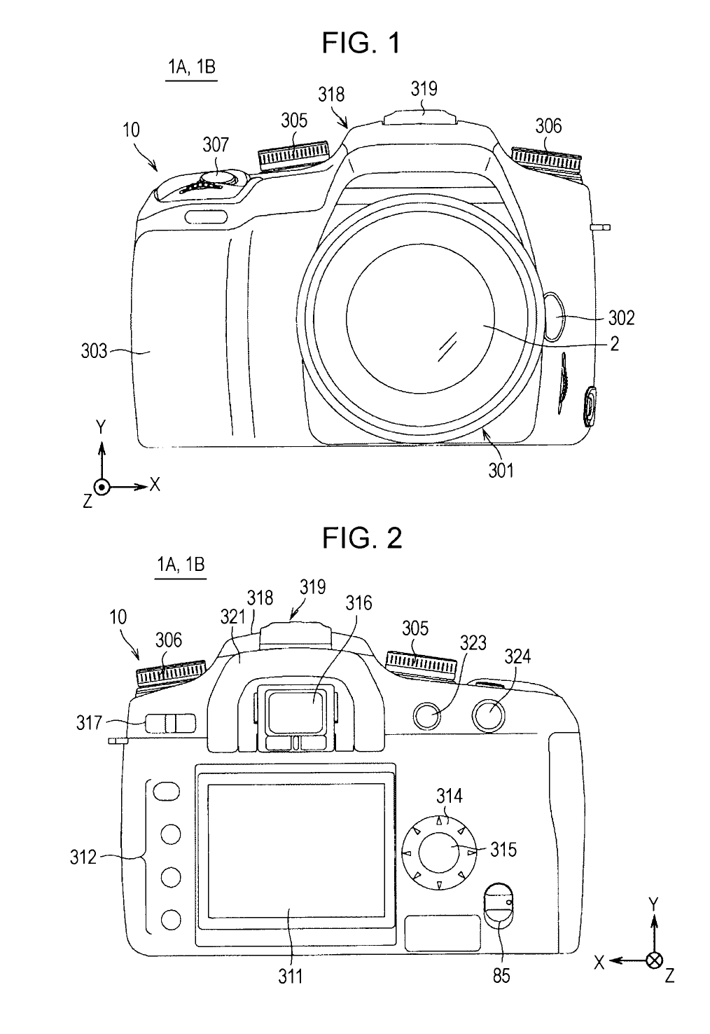

FIGS. 1 and 2 show the exterior configuration of an image-capturing apparatus 1A according to a first embodiment of the present invention. FIGS. 1 and 2 show a front view and a back view, respectively.

The image-capturing apparatus 1A is configured as, for example, a single-lens reflex digital still camera, and includes a camera body 10, and an interchangeable lens 2 serving as an image-capturing lens that can be attached to and detached from the camera body 10.

More specifically, as shown in FIG. 1, provided on the front side of the camera body 10 are a mount unit 301 in which the interchangeable lens 2 is mounted in substantially the center of the front; a lens release button 302 arranged to the right of the mount unit 301; a grip unit 303 at which gripping is possible; a mode setting dial 305 arranged in the upper left area of the front; a control value setting dial 306 arranged in the upper right area of the front; and a shutter button 307 arranged on the top surface of the grip unit 303.

The interchangeable lens 2 functions as a lens window for receiving light (object light) from an object and also functions as an image-capturing optical system for guiding object light to an image-capturing element 101 arranged inside the camera body 10.

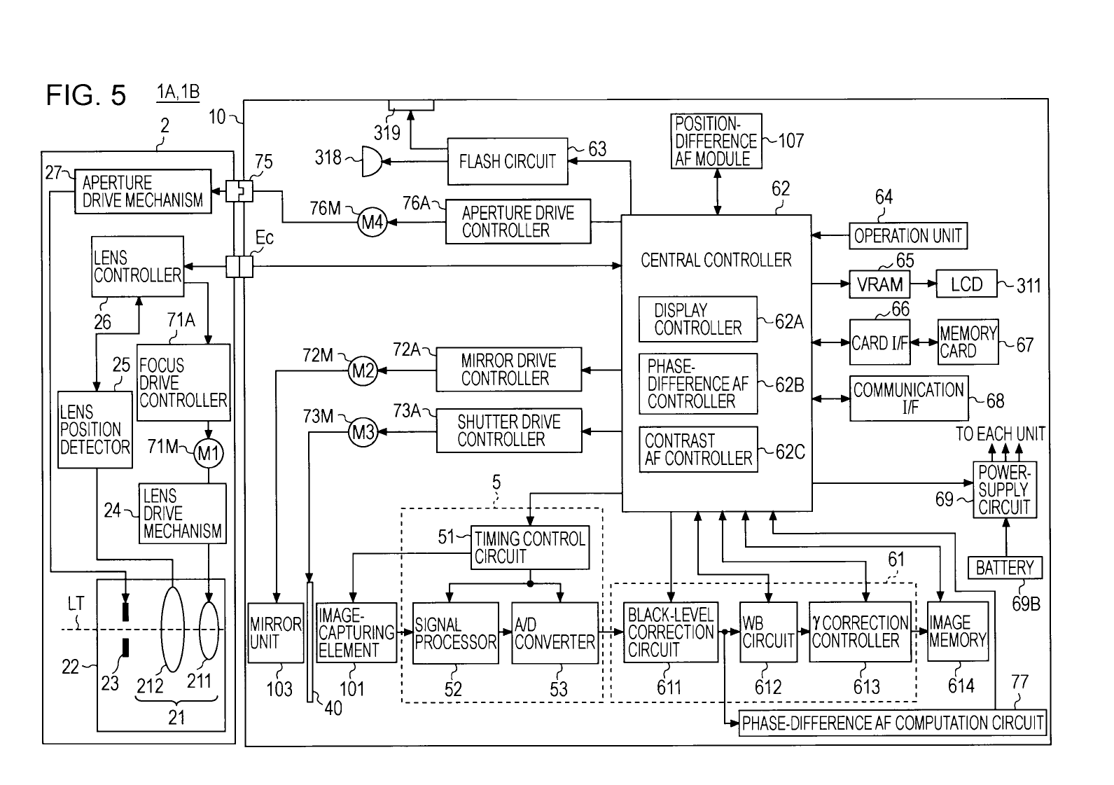

In more detail, the interchangeable lens 2 includes a lens group 21 formed of a plurality of lenses arranged in a serial manner along an optical axis LT (see FIG. 5). The lens group 21 includes a focus lens 211 (FIG. 5) for adjusting focus and a zoom lens 212 (FIG. 5) for performing variable power. As a result of the lenses being driven in the direction of the optical axis LT, focus adjustment and variable power are performed, respectively. The interchangeable lens 2 is provided with an operation ring that is rotatable along the outer peripheral surface of a lens barrel at an appropriate outer peripheral place. The zoom lens 212 is moved in an optical-axis direction in accordance with the rotational direction and the number of revolutions of the operation ring by manual operation or by automatic operation so that the zoom lens 212 is set at a zoom magnification (image-capturing magnification) corresponding to the position of the movement destination thereof.

The mount unit 301 is provided with a connector Ec (see FIG. 5) for making electrical connection with the mounted interchangeable lens 2 and a coupler 75 (FIG. 5) for making mechanical connection.

The lens exchange button 302 is a button that is pressed when the interchangeable lens 2 mounted in the mount unit 301 is to be demounted.

The grip unit 303 is a part at which the image-capturing apparatus 1A is gripped by an image-capturing person (user) during image capturing. A battery compartment and a card compartment (neither of which is shown) are provided inside the grip unit 303. The battery compartment is housed with a battery 69B (see FIG. 5) as a power supply for the image-capturing apparatus 1A, and the card compartment is housed with a memory card 67 (FIG. 5) for recording image data of captured images in such a manner that the memory card 67 can be attached thereto and detached therefrom. The grip unit 303 may be provided with a grip sensor for detecting whether the user has gripped the grip unit 303.

The mode setting dial 305 and the control value setting dial 306 are made of members that are substantially disc shaped and that are rotatable within the plane approximately parallel to the top surface of the camera body 10. The mode setting dial 305 is used to select various kinds of modes (various kinds of image-capturing modes (a portrait image-capturing mode, a landscape image-capturing mode, a full auto image-capturing mode, etc.) installed in the image-capturing apparatus 1A, a reproduction mode in which a captured image is reproduced, a communication mode in which data communication is performed with external devices, etc.). On the other hand, the control value setting dial 306 is used to set control values for various kinds of functions installed in the image-capturing apparatus 1A.

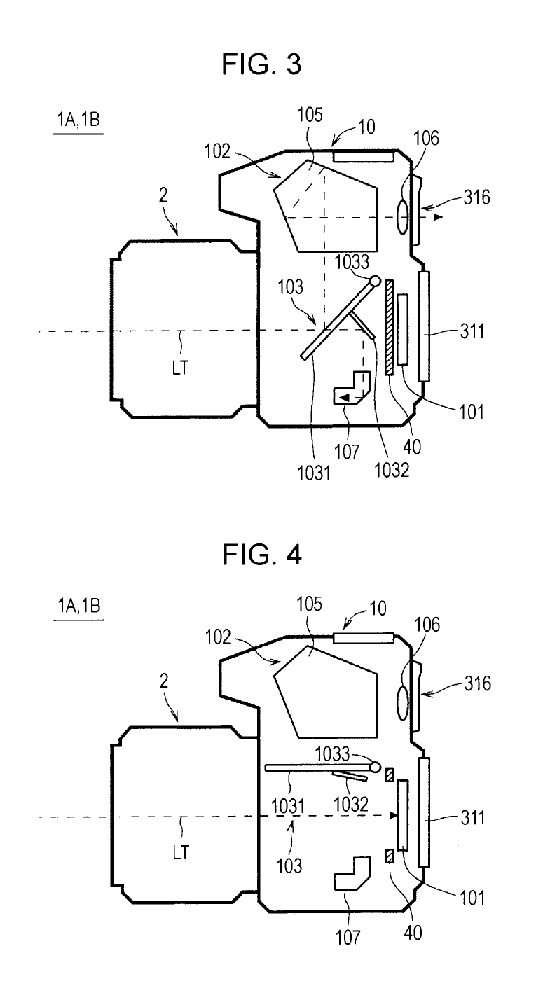

The shutter button 307 is a press switch capable of detecting a “half-pressed state” in which the shutter button 307 is pushed in halfway and a “fully pressed state” in which the shutter button 307 is pushed in further. When the shutter button 307 is half-pressed (state S1) in the image-capturing mode, preparatory operations (preparatory operations, such as setting of an exposure control value and focus detection) for capturing a still image of an object are performed. When the shutter button 307 is fully pressed (state S2), image capturing operations (a series of operations for exposing the image-capturing element 101 (see FIG. 3), performing predetermined image processing on an image signal obtained by the exposure, and recording the image signal in a memory card or the like) are performed.

As shown in FIG. 2, provided on the back side of the camera body 10 are a liquid-crystal display (LCD) 311 functioning as a display unit; a finder window 316 disposed above the LCD 311; an eyecup 321 that surrounds the finder window 316; a main switch 317 disposed to the left of the finder window 316; an exposure correction button 323 and an AE lock button 324, which are disposed to the right of the finder window 316; a flash unit 318 disposed above the finder window 316; and a connection terminal unit 319 disposed above the finder window 316. Provided on the back side of the camera body 10 are a setting button group 312 arranged to the left of the LCD 311; a direction selection key 314 arranged to the right of the LCD 311; a push button 315 arranged in the center of the direction selection key 314; and a display selector switch 85 arranged to the lower right of the direction selection key 314.

The LCD 311 includes a color liquid-crystal panel capable of performing image display, so that an image captured using the image-capturing element 101 (see FIG. 3) is displayed or a recorded image is reproduced and displayed and also, a screen for setting functions and modes installed in the image-capturing apparatus 1A is displayed. In place of the LCD 311, an organic EL display device or a plasma display device may be used.

The finder window (eyepiece window) 316 forms an optical finder (OVF), and light (object light) forming an object image, which has been transmitted through the interchangeable lens 2, is guided to the finder window 316. By viewing the finder window 316, it is possible for the user to visually recognize an object image captured in practice by the image-capturing element 101.

The main switch 317 is formed of a two-contact slide switch that slides side by side. When the main switch 317 is set to the left, the power supply of the image-capturing apparatus 1A is switched on, and when the main switch 317 is set to the right, the power supply is switched off.

The flash unit 318 is configured as a pop-up built-in flash. On the other hand, in a case where an external flash or the like is to be mounted in the camera body 10, connection is made using the connection terminal unit 319.

The eyecup 321 functions as a light-shielding member, which suppresses intrusion of extraneous light to the finder window 316.

The exposure correction button 323 is a button for manually adjusting exposure values (an aperture value and a shutter speed). The AE lock button 324 is a button for fixing exposure.

The setting button group 312 includes buttons for performing operations for various kinds of functions installed in the image-capturing apparatus 1A. Examples of the setting button group 312 include a menu button for displaying the menu screen on the LCD 311 and a menu switching button for switching between content displayed on the menu screen.

The direction selection key 314 has an annular member including a plurality of press units (triangular marks in the figure) arranged at fixed intervals in the circumferential direction, so that a pressing operation of a press unit is detected using a contact (switch) (not shown) provided in such a manner as to correspond to each press unit. The push button 315 is arranged in the center of the direction selection key 314. The direction selection key 314 and the push button 315 are used to input instructions for changing image-capturing magnification (the movement of the zoom lens 212 (see FIG. 5) in the wide direction or in the tele direction), for advancing the frame of a recording image to be reproduced on the LCD 311 or the like, and for setting image capturing conditions (an aperture value, a shutter speed, presence or absence of flash light emission, and the like).

The display selector switch 85 is formed of a two-point slide switch. When the contact is set at an “optical” position in the upper area, an optical finder mode (also referred to as an “OVF mode”) is selected, and an object image is displayed within the field of view of the optical finder. As a result, it is possible for the user to perform a composition determination operation (framing) by visually recognizing an object image displayed within the field of view of the optical finder via the finder window 316.

On the other hand, when the contact of the display selector switch 85 is set at a “monitor” position in the lower area, an electronic finder mode (also referred to as an “EVF mode” or a “live-view mode”) is selected, and a live-view image related to the object image is displayed on the LCD 311 in a movie-like mode. As a result, it is possible for the user to perform framing by visually recognizing a live-view image displayed on the LCD 311.

As described above, it is possible for the user to switch the finder mode by operating the display selector switch 85. In the image-capturing apparatus 1A, it is possible to perform the composition determination of an object by using an electronic finder in which a live-view display is performed or by using an optical finder. Internal Configuration of Image-Capturing Apparatus 1A Next, the internal configuration of the image-capturing apparatus 1A will be described. FIGS. 3 and 4 are longitudinal sectional views of the image-capturing apparatus 1A. As shown in FIG. 3, an image-capturing element 101, a finder unit 102 (finder optical system), a mirror unit 103, a phase-difference AF module (also referred to simply as an “AF module”) 107, and the like are provided inside the camera body 10.

The image-capturing element 101 is arranged perpendicularly to the optical axis LT along the optical axis LT of the lens group 21 provided in the interchangeable lens 2 in a case where the interchangeable lens 2 is mounted in the camera body 10. For the image-capturing element 101, for example, a CMOS color-area sensor (CMOS image-capturing element) in which a plurality of pixels each having a photodiode are arranged in matrix in a two dimensional manner is used. The image-capturing element 101 generates an analog electrical signal (image signal) of components of each color of R (red), G (green), and B (blue), which are related to an object image that is formed as an image after passing through the interchangeable lens 2, and outputs an image signal of each color of R, G, and B.

Furthermore, the image-capturing element 101 has pixels for detecting a phase difference on the image-capturing plane thereof, the details of which will be described later.

In the optical axis LT, the mirror unit 103 is arranged at a position at which object light is reflected toward the finder unit 102. The object light passing through the interchangeable lens 2 is reflected upward by the mirror unit 103 (a main mirror 1031 (to be described later)) and also, some of the object light is transmitted through the mirror unit 103.

The finder unit 102 includes a pentaprism 105, an eyepiece lens 106, and a finder window 316. The pentaprism 105 is a prism that has a pentagonal shape in cross section, by which the top and bottom and the left and right of an object image formed by light entering the lower surface of the prism are flipped by the reflection in the inside and formed as an erect image. The eyepiece lens 106 guides the light of the object image formed as an erect image by the pentaprism 105 to the outside of the finder window 316. With such a configuration, the finder unit 102 functions as an optical finder for confirming an object field at image-capturing waiting time before actual image capturing.

The mirror unit 103 includes the main mirror 1031 and a sub-mirror 1032. On the back side of the main mirror 1031, the sub-mirror 1032 is rotatably provided in such a manner as to fall toward the back side of the main mirror 1031. Some of the object light that has been transmitted through the main mirror 1031 is reflected by the sub-mirror 1032, and the reflected object light enters the AF module 107.

The mirror unit 103 is configured as a so-called quick return mirror. For example, during exposure time (during actual image capturing) (see FIG. 4), the mirror unit 103 jumps upward by using a rotational axis 1033 as a fulcrum and reaches a retracted state (mirror-up state) from the light path of the object light. At this time, when the mirror unit 103 is stopped at a position below the pentaprism 105, the sub-mirror 1032 becomes folded so as to be substantially parallel to the main mirror 1031. As a result, the object light from the interchangeable lens 2 reaches the image-capturing element 101 without being shielded by the mirror unit 103, and the image-capturing element 101 is exposed. When the image-capturing operation in the image-capturing element 101 is completed, the mirror unit 103 returns to the original position (the position shown in FIG. 3) and reaches a mirror-down state.

Furthermore, by causing the mirror unit 103 to reach a mirror-up state before actual image capturing (image capturing for image recording purpose), it becomes possible for the image-capturing apparatus 1A to perform a live-view (preview) display in which an object is displayed on the LCD 311 in a movie-like mode on the basis of image signals generated in sequence by the image-capturing element 101.

The AF module 107 is configured as a so-called AF sensor formed of a range-finding element (also referred to as a “range-finding sensor”) for detecting focusing information of an object. The AF module 107 is disposed in the bottom part of the mirror unit 103 and has a phase-difference detection function of generating a phase-difference detection signal corresponding to the degree of focusing of an object image. That is, in a case where the object is to be confirmed by the user by using the finder window 316 during image-capturing waiting time, as shown in FIG. 3, the object light is guided to the AF module 107 in a state in which the main mirror 1031 and the sub-mirror 1032 are made down and also, a phase-difference detection signal is output from the AF module 107.

On the front side in the optical-axis direction of the image-capturing element 101, a shutter unit 40 is arranged. The shutter unit 40 includes a curtain that moves in the up-and-down direction, and is configured as a mechanical focal-plane shutter for performing a light-path opening operation and a light-path shielding operation for object light that is guided to the image-capturing element 101 along the optical axis LT. The shutter unit 40 can be omitted in a case where the image-capturing element 101 is a completely electronic shutter capable image-capturing element.

### Electrical Configuration of Image-Capturing Apparatus 1A

FIG. 5 is a block diagram showing the electrical configuration of the image-capturing apparatus 1A. Here, members identical to those in FIGS. 1 to 4 are designated with the same reference numerals. For the sake of description, the electrical configuration of the interchangeable lens 2 will be described.

The interchangeable lens 2 includes, in addition to the lens group 21 constituting the above-described image-capturing optical system, a lens drive mechanism 24, a lens position detector 25, a lens controller 26, and an aperture drive mechanism 27.

In the lens group 21, the focus lens 211, the zoom lens 212, and the aperture 23 for adjusting the amount of light that enters the image-capturing element 101 are held in the direction of the optical axis LT (FIG. 3) within the lens barrel. Object light received by the lens group 21 is formed as an image in the image-capturing element 101. In automatic focusing (AF) control, focus adjustment is performed by the focus lens 211 being driven in the direction of the optical axis LT by an AF actuator 71M inside the interchangeable lens 2.

On the basis of the AF control signal supplied from the central controller 62 via the lens controller 26, the focus drive controller 71A generates a driving control signal for moving the focus lens 211 to the focus position, and controls the AF actuator 71M by using the driving control signal. The AF actuator 71M is formed of a stepping motor and the like, and supplies a lens driving force to the lens drive mechanism 24.

The lens drive mechanism 24 is formed of, for example, a helicoid and gears (not shown) with which the helicoid is rotated. By receiving a driving force from the AF actuator 71M, the lens drive mechanism 24 causes the focus lens 211 and the like to be driven in a direction parallel to the optical axis LT. The movement direction and the amount of movement of the focus lens 211 accord with the rotational direction and the number of revolutions of the AF actuator 71M, respectively.

The lens position detector 25 includes an encoding plate on which a plurality of code patterns are formed at predetermined pitches in the direction of the optical axis LT within the range of the movement of the lens group 21, and an encoder brush that moves integrally with a lens while slidably contacting the encoding plate, and detects the amount of movement when the focus of the lens group 21 is to be adjusted. The lens position detected by the lens position detector 24 is output as, for example, the number of pulses.

The lens controller 26 includes a microcomputer in which, for example, a ROM storing control programs or a memory such as a flash memory storing data on status information is incorporated.

The lens controller 26 has a communication function of performing communication with the central controller 62 of the camera body 10 via the connector Ec. As a result, for example, status information data, such as the focus distance, the aperture value, the in-focus distance, or the peripheral light amount status of the lens group 21, and the position information on the focus lens 211, which is detected by the lens position detector 25, can be transmitted to the central controller 62. Also, for example, data on the amount of driving of the focus lens 211 can be received from the central controller 62.

Upon receiving the driving force from an aperture driving actuator 76M via the coupler 75, the aperture drive mechanism 27 changes the aperture diameter of the aperture 23.

Next, the electrical configuration of the camera body 10 will be described. The camera body 10 includes, in addition to the above-described image-capturing element 101, the shutter unit 40 and the like, an analog front end (AFE) 5, an image processor 61, an image memory 614, a central controller 62, a flash circuit 63, an operation unit 64, a VRAM 65, a card I/F 66, a memory card 67, a communication I/F 68, a power-supply circuit 69, a battery 69B, a mirror driving controller 72A, a shutter driving controller 73A, and an aperture driving controller 76A.

The image-capturing element 101 is formed of a CMOS color-area sensor, as described earlier. A timing control circuit 51 (to be described later) controls image-capturing operations, such as the start (and the completion) of the exposure operation of the image-capturing element 101, selection of the output of each pixel provided in the image-capturing element 101, and the reading of a pixel signal.

The AFE 5 has functions of supplying, to the image-capturing element 101, a timing pulse at which a predetermined operation is performed, performing predetermined signal processing on an image signal output from the image-capturing element 101 so that the image signal is converted into a digital signal, and outputting the digital signal to the image processor 61. The AFE 5 is configured to have a timing control circuit 51, a signal processor 52, an A/D converter 53, and the like.

The timing control circuit 51 generates predetermined timing pulses (pulses for generating a vertical scanning pulse φVn, a horizontal scanning pulse φVm, a reset signal φVr, and the like) on the basis of a reference clock output from the central controller 62, and outputs the timing signal to the image-capturing element 101, thereby controlling the image-capturing operation of the image-capturing element 101. By outputting predetermined timing pulses to the signal processor 52 and the A/D converter 53, respectively, the operations of the signal processor 52 and the A/D converter 53 are controlled.

The signal processor 52 performs predetermined analog signal processing on an analog image signal output from the image-capturing element 101. The signal processor 52 includes a correlated double sampling (CDS) circuit, an automatic gain control (AGC) circuit, a clamp circuit, and the like. On the basis of a timing pulse output from the timing control circuit 51, the A/D converter 53 converts analog image signals of R, G, and B, which are output from the signal processor 52, into digital image signals made up of a plurality of bits (for example, 12 bits).

The image processor 61 creates an image file by performing predetermined signal processing on image data output from the AFE 5. The image processor 61 is configured to have a black-level correction circuit 611, a white-balance (WB) control circuit 612, a gamma (γ) correction circuit 613, and the like. The image data received by the image processor 61 is once written in an image memory 614 in synchronization with the reading of the image-capturing element 101. Hereinafter, access is made to the image data written in the image memory 614, and processing in each block of the image processor 61 is performed.

The black-level correction circuit 611 corrects the black level of each digital image signal of R, G, and B, which is A/D-converted by the A/D converter 53, into a reference black level.

On the basis of the reference for white in accordance with the light source, the white-balance control circuit 612 performs level conversion (white-balance (WB) adjustment) of a digital signal of components of each color of R (red), G (green), and B (blue). More specifically, on the basis of the WB adjustment data supplied from the central controller 62, the white-balance control circuit 612 specifies, from luminance data, color saturation data, and the like, a portion that is estimated to be originally white color in an image-capturing object, determines the average of the components of each of R, G, and B of that portion, a G/R ratio, and a G/B ratio, and performs level correction by using these ratios as correction gains of R and B.

The gamma correction circuit 613 corrects gradation characteristics of WB-adjusted image data. More specifically, by using a preset gamma correction table, the gamma correction circuit 613 performs, for each color component, non-linear conversion of the level of the image data, and offset adjustment.

The image memory 614 is a memory used as a work area in which, during the image-capturing mode, image data output from the image processor 61 is temporarily stored and also, a predetermined process is performed on the image data by the central controller 62. Furthermore, during the reproduction mode, image data read from the memory card 67 is temporarily stored.

The central controller 62 is configured as a microcomputer, which mainly includes a CPU, a memory, a ROM, and the like. The central controller 62 reads programs stored in the ROM and causes the CPU to execute the programs, thereby implementing various kinds of functions of the image-capturing apparatus 1A.

As a result of the execution of the programs, the central controller 62 realizes a display controller 62A, a phase-difference AF controller 62B, and a contrast AF controller 62C in a functional manner.

The display controller 62A controls display content on the LCD 311. For example, the display controller 62A causes each of a plurality of images that are continuously obtained by the image-capturing element 101 to be sequentially displayed as a live-view image on the LCD 311.

The phase-difference AF controller 62B performs an automatic focusing operation by performing focus position detection by using a phase-difference detection method. More specifically, on the basis of a phase-difference detection signal obtained by the AF module 107 or an output signal from a phase-difference AF computation circuit 77 (to be described later), the phase-difference AF controller 62B performs a focus lens position specifying operation that specifies the position (focus lens position 211) of an image-capturing lens (in more detail, a focus lens) during in-focus.

The contrast AF controller 62C performs an automatic focusing operation (also referred to as a “contrast AF operation”) by performing focus position detection by using a contrast detection method. More specifically, the contrast AF controller 62C performs an evaluation value computation operation for determining an evaluation value in accordance with the contrast of the object images with regard to a plurality of captured images obtained at different lens positions, respectively, and a focus lens position specifying operation for specifying a lens position at which the evaluation value is optimized (e.g., minimized) as a focus lens position.

The flash circuit 63 controls the amount of light emission of the flash unit 318 or an external flash connected to the connection terminal unit 319 so as to be set to the amount of light emission set by the central controller 62.

The operation unit 64 includes the mode setting dial 305, the control value setting dial 306, the shutter button 307, the setting button group 312, the direction selection key 314, the push button 315, the main switch 317, etc., and is used to input operation information to the central controller 62.

The VRAM 65 is a buffer memory between the central controller 62 and the LCD 311, which has a storage capacity of image signals corresponding to the number of pixels of the LCD 311. The card I/F 66 is an interface for enabling transmission and reception of signals between the memory card 67 and the central controller 62. The memory card 67 is a recording medium for storing image data generated by the central controller 62. The communication I/F 68 is an interface for enabling transmission of image data and the like to a personal computer or another external device.

The power-supply circuit 69 is formed of, for example, a constant voltage circuit and the like, and generates a voltage for driving the entire image-capturing apparatus 1A, such as the controller (such as the central controller 62), the image-capturing element 101, and other various kinds of driving units. Control of electricity supply to the image-capturing element 101 is performed in accordance with a control signal supplied from the central controller 62 to the power-supply circuit 69. The battery 69B is a power supply that is formed of a primary battery such as an alkali dry battery or a secondary battery such as a nickel-metal-hydride rechargeable battery, and that supplies electric power to the entire image-capturing apparatus 1A.

The mirror driving controller 72A generates a driving signal for driving the mirror driving actuator 72M in accordance with the switching of the finder mode or the timing of the image capturing operation. The mirror driving actuator 72M is an actuator that causes the mirror unit 103 (quick return mirror) to be rotated in a horizontal posture or in an inclined posture.

The shutter driving controller 73A generates a driving control signal for the shutter driving actuator 73M on the basis of the control signal supplied from the central controller 62. The shutter driving actuator 73M is an actuator for driving the opening/closing of the shutter unit 40.

The aperture driving controller 76A generates a driving control signal for the aperture driving actuator 76M on the basis of the control signal supplied from the central controller 62. The aperture driving actuator 76M supplies a driving force to the aperture drive mechanism 27 via the coupler 75.

The camera body 10 includes a phase-difference AF computation circuit 77 for performing computations necessary at auto-focus (AF) control time on the basis of image data whose black level has been corrected, which is output from the black-level correction circuit 611.

In the following, a phase-difference AF operation using an output signal from the phase-difference AF computation circuit 77 will be described in detail and also, an AF operation that can be performed by the image-capturing apparatus 1A will be described.

### Image-Capturing Element 101

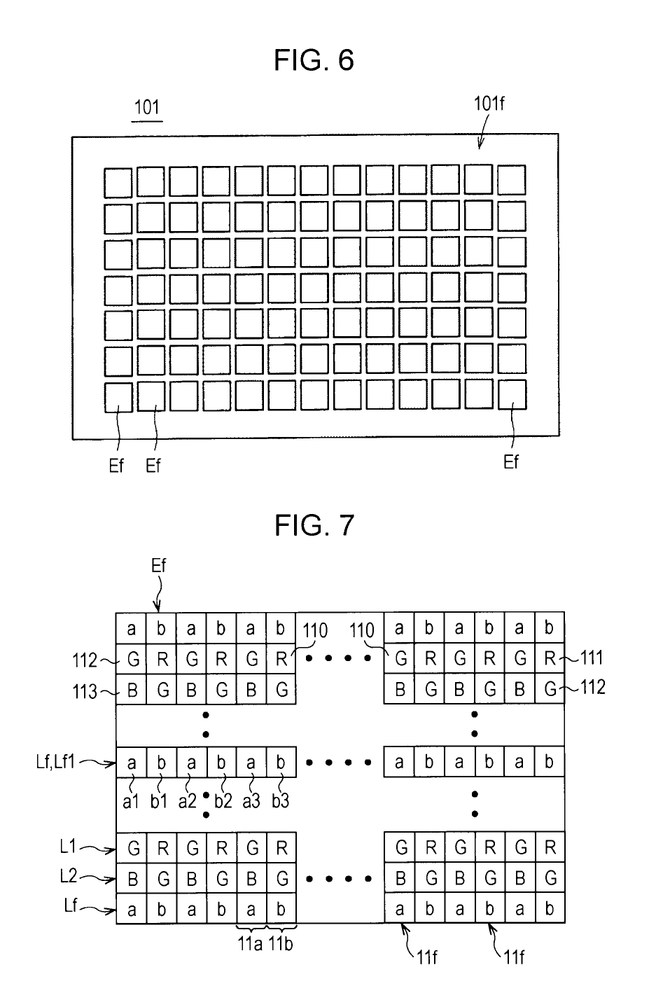

The image-capturing apparatus 1A is configured in such a manner that phase-difference AF is possible by receiving light that is passed through (transmitted through) different portions within the exit pupil of the image-capturing lens by the image-capturing element 101. In the following, first, the configuration of the image-capturing element 101 and the principles of phase-difference AF using the image-capturing element 101 will be described. FIGS. 6 and 7 illustrate the configuration of the image-capturing element 101.

As shown in FIG. 6, the image-capturing element 101 is configured in such a manner as to have an AF area Ef defined in matrix in an image-capturing plane 101f thereof, so that focus detection of a phase-difference detection method is possible in each AF area Ef.

In each AF area Ef, a group of pixels (also referred to as “ordinary pixels”) 110 for obtaining (capturing) an image, which are formed of an R pixel 111, a G pixel 112, and a B pixel 113 in which color filters of each of R (red), G (green), and B (blue) are disposed in a photodiode, is provided and also, a group of pixels (hereinafter also referred to as “AF pixels” or “photoelectric conversion cells”) 11f for performing phase-difference AF are provided (see FIG. 7).

Then, in the AF area Ef, a Gr line L1 in which a G pixel 112 and an R pixel 111 are alternately arranged in the horizontal direction as a horizontal line of ordinary pixels, and a Gb line L2 in which a B pixel 113 and a G pixel 112 are alternately arranged in the horizontal direction, are formed. As a result of the Gr line L1 and the Gb line L2 being alternately arranged in the vertical direction, Bayer arrangement is formed.

Furthermore, in the AF area Ef, an AF line Lf formed by AF pixels 11f arranged in the horizontal direction is formed. The AF line Lf is arranged every predetermined number of horizontal lines (e.g., six) of the ordinary pixels. In the AF area Ef, for example, approximately 20 AF lines Lf are provided.

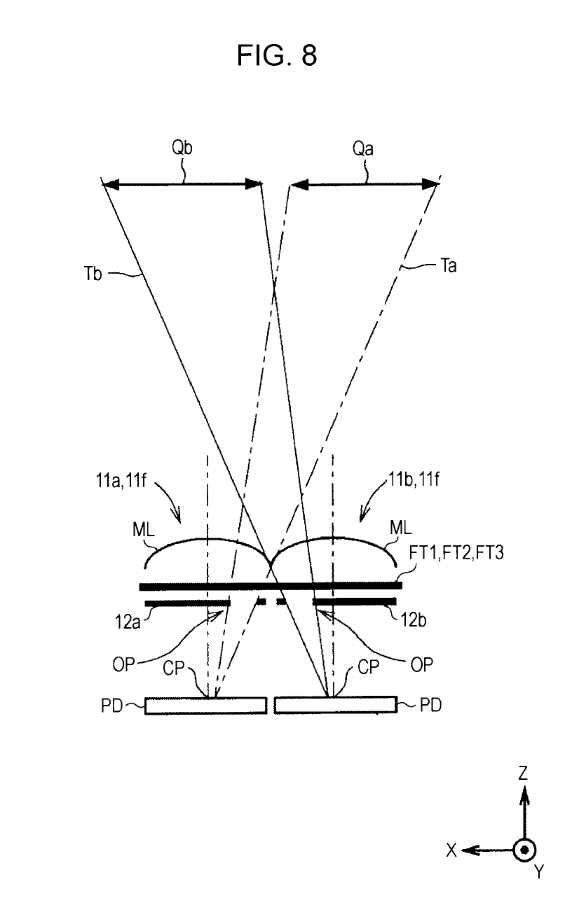

Next, the principles of phase-difference AF using an AF line Lf will be described in detail. FIG. 8 is a longitudinal sectional view of AF pixels 11f.

In the AF line Lf, a pair of pixels 11a and 11b (see FIG. 8) that receive a light flux Ta from the right-side portion Qa of the exit pupil and a light flux Tb from the left-side portion Qb thereof, respectively, with regard to the interchangeable lens 2 are alternately arranged in the horizontal direction.

More specifically, an AF pixel (hereinafter also referred to as a “first AF pixel”) 11a has a microlens ML for collecting object light, an optical filter (also referred to as a “band-pass filter”) FT1 for allowing light in a specific wavelength range to be transmitted therethrough, a light-shielding plate (also referred to as a “light-shielding film”) 12a having an opening OP1 in a slit (rectangular) shape, and a photoelectric converter (also referred to as a “light-receiving element” or a “photodiode”) PD for receiving object light and generating an electrical signal corresponding to the intensity of the object light. The light-shielding plate 12a of the first AF pixel 11a has an opening OP offset in a specific direction (here, in the right direction (-X direction)) by using the center CP of the photodiode PD directly below as a reference.

On the other hand, an AF pixel (hereinafter also referred to as a “second AF pixel”) 11b has a microlens ML, an optical filter FT1, a light-shielding plate 12b having an opening OP in a slit shape, and a photoelectric converter PD. The light-shielding plate 12b of the second AF pixel 11b has an opening OP offset in a direction (here, in the left direction (+X direction)) opposite to the specific direction by using the center CP of the photodiode PD directly below as a reference.

In the AF line Lf, such a pair of AF pixels 11a and 11b are alternately arranged in the line direction. The role of the optical filter FT1 will be described later.

In the pair of AF pixels 11a and 11b having the above-described configuration, a light flux Ta from the right-side portion Qa of the exit pupil passes through the microlens ML, the optical filter FT1, and the opening OP of the light-shielding plate 12a, and is received by the photodiode PD of the first AF pixel 11a. Furthermore, a light flux Tb from the left-side portion Qb of the exit pupil passes through the microlens ML, the optical filter FT1, and the opening OP of the light-shielding plate 12b, and is received by the photodiode PD of the second AF pixel 11b. In other words, in the pair of pixels 11a and 11b, the light fluxes Ta and Tb of the object light that has been transmitted through the right-side portion Qa and the left-side portion Qb (pair of portion areas) in the exit pupil of the interchangeable lens 2 are received, respectively.

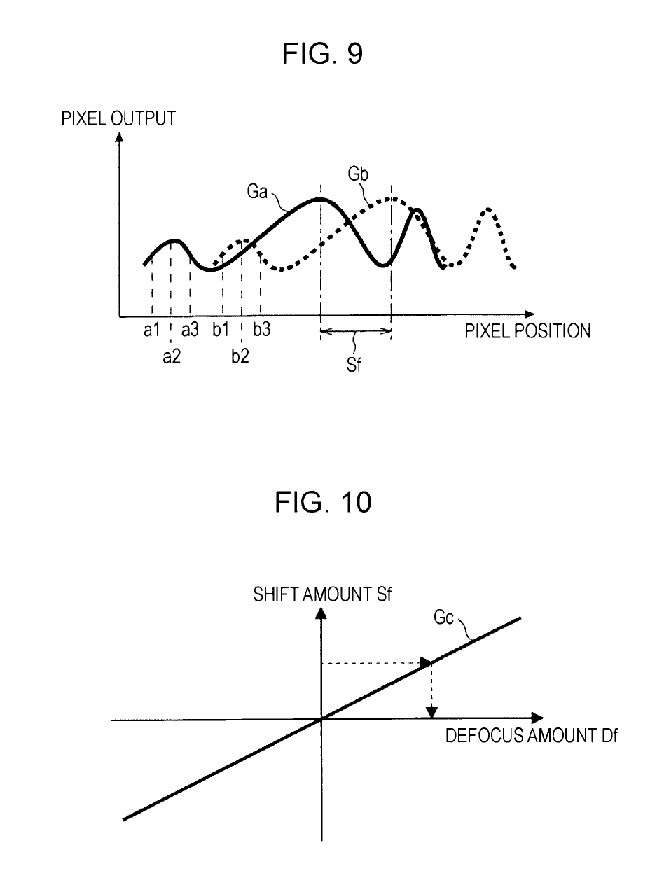

In the following, the pixel output of the first AF pixel 11a will be referred to as “pixel output of sequence a”, and the pixel output of the second AF pixel 11b will be referred to as “pixel output of sequence b”. A description will be given of, for example, the relationship between the pixel output of sequence a and the pixel output of sequence b, which are obtained from the pixel arrangement of the AF pixels 11f arranged in one certain AF line Lf1 (see FIG. 7). FIG. 9 shows the pixel output of the AF line Lf1. FIG. 10 shows the relationship between the shift amount Sf and the defocus amount Df of pixel output.

In the AF line Lf1, the light fluxes Ta and Tb from both sides of the exit pupil are received by the first AF pixel 11a and the second AF pixel 11b, respectively. Here, the pixel output of sequence a in the AF line Lf1 including pixels a1 to a3 of sequence a, which are arranged as shown in FIG. 7, is expressed as a graph Ga (shown using the solid line) in FIG. 9. On the other hand, the pixel output of sequence b in the AF line Lf1 including pixels b1 to b3 of sequence b, which are arranged as shown in FIG. 7, is expressed as a graph Gb (shown using the dashed line).

When the graph Ga and the graph Gb shown in FIG. 9 are compared with each other, it can be seen that, for the pixel output of sequence a and the pixel output of sequence b, a phase difference has occurred in an offset amount (shift amount) Sf in the line direction (in other words, the alternate arrangement direction of the AF pixels 11f) of the AF line Lf1.

On the other hand, the relationship between the above-described shift amount Sf and the amount (the defocus amount) Df that the focal plane is defocused to the image-capturing plane of the image-capturing element 101 is represented by a graph Gc of a primary function shown in FIG. 12. The inclination of the graph Gc can be obtained in advance by factory tests, and the like.

Therefore, after the shift amount Sf is determined by the phase-difference AF computation circuit 77 on the basis of the output from the AF line Lf of the image-capturing element 101, the phase-difference AF controller 62B computes the defocus amount Df on the basis of the graph Gc of FIG. 10 and supplies the driving amount corresponding to the computed defocus amount Df to the focus lens 211, making possible phase-difference AF that causes the focus lens 211 to be moved to the focus position.

As described above, it is possible for the image-capturing apparatus 1A to perform an automatic focusing operation (also referred to as a “phase-difference AF operation” by the image-capturing element 101) of a phase-difference detection method using an output signal from the AF pixel 11f incorporated on the photoreceiving surface of the image-capturing element 101.

Furthermore, the image-capturing apparatus 1A has functions of performing, in addition to a phase-difference AF operation by the image-capturing element 101, a phase-difference AF operation and a contrast AF operation by the AF module 107. Whether or not each of these AF operations can be performed differs according to the selected finder mode.

More specifically, in the OVF mode, a mirror-down state (FIG. 3) is reached, and some of the object light is guided to the AF module 107. As a consequence, as an AF operation, an AF operation (also referred to as a “phase-difference AF operation” by the “AF module 107”) of a phase-difference detection method using an output signal from a light-receiving element inside the AF module 107 is made possible.

On the other hand, in the EVF mode, a mirror-up state (FIG. 4) is reached, and the object light is guided to the image-capturing element 101. As a consequence, as an AF operation, a phase-difference AF operation and/or a contrast AF operation by the image-capturing element 101 are made possible. As an AF operation in the EVF mode, which one of the two AF operations (a phase-difference AF operation and a contrast AF operation by the image-capturing element 101) using the image-capturing element 101 should be performed can be determined by performing a menu operation on the menu screen.

### Optical Filter FT1

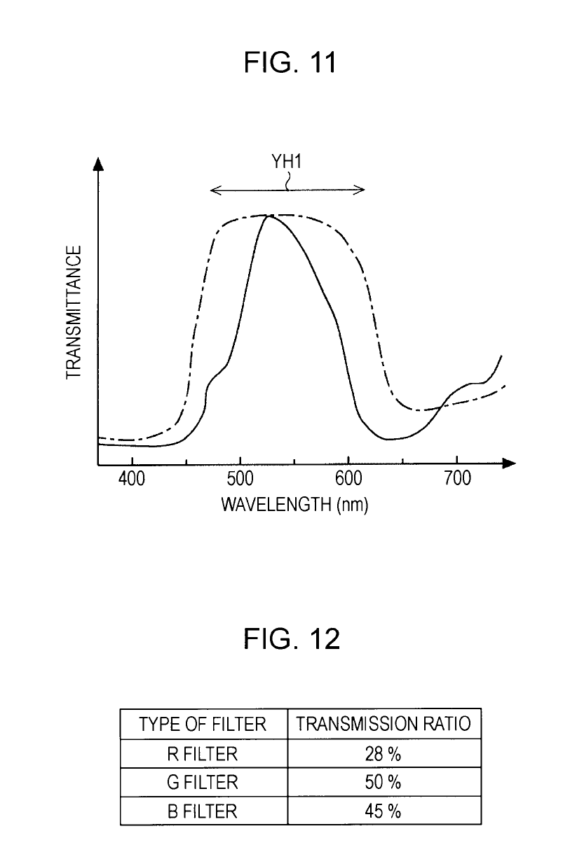

Next, a description will be given below of an optical filter FT1 provided in the AF pixel 11f. FIG. 11 shows the transmittance of a green primary-color transmission filter (primary-color filter) and the transmittance of an optical filter FT1. FIG. 12 shows the transmission ratio of white light of each primary-color transmission filter of RGB. In FIG. 11, the transmittance of the green primary-color transmission filter is indicated using the solid line, and the transmittance of the optical filter FT1 is indicated using the short dashed line. In FIG. 12, the ratio at which emitted white light is transmitted is shown.

The optical filter FT1 is arranged on the light-receiving side of the AF pixel 11f, and has a function of allowing visible light in a specific wavelength region within the object light guided from the image capturing optical system to be selectively transmitted therethrough.

More specifically, as shown in FIG. 11, in the image-capturing apparatus 1A, as an optical filter, an optical filter FT1 for allowing visible light in a wavelength range (a wavelength range indicated by a double-sided arrow YH1 in FIG. 11) wider than a wavelength range of visible light that is allowed by a green primary-color transmission filter (in more detail, a green primary-color transmission filter arranged in the G pixel 112 for image capturing) to be transmitted therethrough to be transmitted therethrough is adopted.

As described above, according to the fact that the optical filter FT1 having the characteristics of FIG. 11 is adopted as an optical filter, when compared to the case in which a green primary-color transmission filter is adopted, it becomes possible to receive, using the photodiode PD, visible light of a comparatively wide wavelength range, that is, object light of colors other than green. Therefore, in the image-capturing apparatus 1A, even in a case where much colors other than green are contained in the reflected light (generated light) of the object, it is possible to perform focus detection with high accuracy.

Furthermore, as shown in FIG. 12, the transmission ratio of each primary-color transmission filter of RGB is low. As a consequence, if a primary-color transmission filter is adopted as an optical filter, insufficient light occurs with respect to an object having a low amount of light, and focus detection becomes not possible.

However, according to the fact that the optical filter FT1 that causes visible light in a wavelength range wider than that of a green primary-color transmission filter to be transmitted therethrough is adopted, since much more light of object light can be received in the photodiode PD, it is possible to perform focus detection with respect to an object having a low luminance.

### Second Embodiment

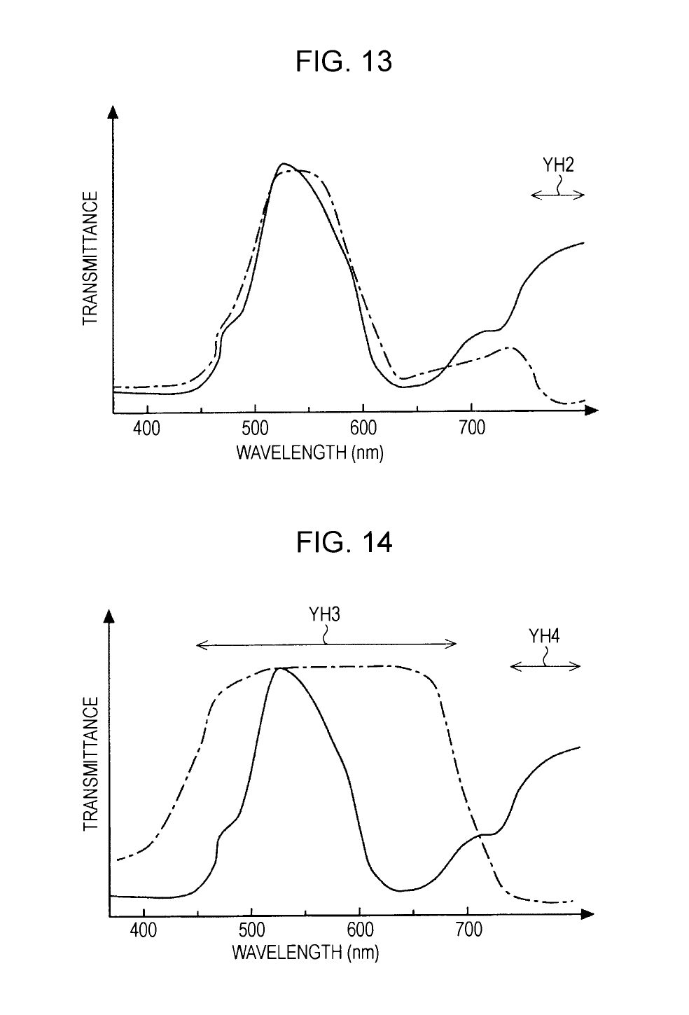

Next, a second embodiment of the present invention will be described. FIG. 13 shows the transmittance of a green primary-color transmission filter and the transmittance of an optical filter FT2 according to the second embodiment. In FIG. 13, the transmittance of a green primary-color transmission filter is indicated using the solid line, and the transmittance of an optical filter FT2 is indicated using the short dashed line.

For an image-capturing apparatus 1B according to the second embodiment, as an optical filter FT provided in the AF pixel 11f, an optical filter FT2 that causes light in an infrared range (infrared ray) within object light to not be transmitted therethrough is adopted.

More specifically, as shown in FIG. 13, the optical filter FT2 having a low transmittance of light in an infrared range (in FIG. 13, a wavelength range indicated using the double-sided arrow YH2) is adopted. As a result, it is possible to decrease the amount of received light of the photodiode PD with regard to light in the infrared range.

As shown in FIG. 13, in an ordinary green primary-color transmission filter, light in the infrared range is not sufficiently shielded. For this reason, in a case where a green primary-color transmission filter is arranged on the light-receiving side of the AF pixel 11f, much of the light in the infrared range contained in the object light passes through the primary-color transmission filters and reaches the photodiode PD.

Even in a case where an optical filter is not arranged on the light-receiving side of the AF pixel 11f, light in the infrared range reaches the photodiode PD.

As described above, when much light in the infrared range is received by the photodiode PD, focus detection accuracy is decreased.

In more detail, the index of refraction of an image-capturing lens differs according to the wavelength of light. Therefore, when a case in which light in the infrared range is received in the photodiode PD is compared with a case in which light in the infrared range is not received, the phase difference (the shift amount Sf) in the line direction between the pixel output of the first AF pixel 11a and the pixel output of the second AF pixel 11b is changed. Here, a graph Gc showing the relationship between the shift amount Sf and the defocus amount Df, shown in FIG. 10, has been obtained in advance by emitting visible light at the time of manufacturing the product. For this reason, in a case where light in the infrared range is received in the photodiode PD and the phase difference is changed, focus detection accuracy is decreased.

However, as described above, according to the fact that the optical filter FT2 whose transmittance of light in the infrared range is low is provided in the AF pixel 11f, when compared to the case in which an optical filter is not provided or a green primary-color transmission filter is provided, the amount of received light in the infrared range in the photodiode PD can be reduced, making it possible to prevent a decrease in focus detection accuracy.

### Modification

The embodiments of the present invention have been described. However, the present invention is not limited to the above-described content.

For example, as an optical filter provided in the AF pixel 11f, an optical filter FT3 having both a function of the optical filter FT1 of the first embodiment and a function of the optical filter FT2 of the second embodiment may be adopted. FIG. 14 shows the transmittance of a green primary-color transmission filter and the transmittance of the optical filter FT3. In FIG. 14, the transmittance of the primary-color transmission filter is indicated using the solid line, and the transmittance of the optical filter FT3 is indicated using the short dashed line.

More specifically, as shown in FIG. 14, an optical filter FT3 for allowing visible light in a wavelength range wider than the wavelength range of visible light that is allowed by the green primary-color transmission filter (in FIG. 14, the wavelength range indicated using the double-sided arrow YH3) to be transmitted therethrough to be transmitted therethrough and for causing light in the infrared range (in FIG. 14, a wavelength range indicated using the double-sided arrow YH4) to not be transmitted therethrough (in other words, having a low transmittance with regard to light in the infrared range) may be used.

According to the fact that such an optical filter FT3 is used, even in a case where much colors other than green are contained in the reflected light (generated light) of the object, it is possible to perform focus detection with high accuracy and also, it is possible to perform focus detection with respect to an object having a low luminance. Furthermore, since the amount of received light in the infrared range can be reduced, it is possible to prevent focus detection accuracy from being decreased.

Here, the optical filter FT3 having both a function of the optical filter FT1 of the first embodiment and a function of the optical filter FT2 of the second embodiment is adopted has been described as an example. In addition, the optical filter FT1 and the optical filter FT2 may be used in an overlapping manner.

It should be understood by those skilled in the art that various modifications, combinations, sub-combinations and alterations may occur depending on design requirements and other factors insofar as they are within the scope of the appended claims or the equivalents thereof.

What is claimed is:

1. An image-capturing element comprising:
a group of first pixels configured to receive object light and generate an image signal representing an object image; and
a group of second pixels configured to receive the object light and generate a ranging signal for detecting a phase difference,
wherein the second pixels each include an optical filter on a light-receiving side thereof, and
wherein the optical filter allows visible light in a wavelength range wider than a wavelength range of visible light that is allowed by a green primary-color filter to be transmitted therethrough within the object light to be transmitted therethrough.

2. The image-capturing element according to claim 1, wherein the group of first pixels include three types of pixels in which a red primary-color filter, a green primary-color filter, and a blue primary-color filter are arranged on a light-receiving side thereof, respectively.

3. An image-capturing element comprising:
a group of first pixels configured to receive object light and generate an image signal representing an object image; and
a group of second pixels configured to receive the object light and generate a ranging signal for detecting a phase difference,
wherein the second pixels each include an optical filter on a light-receiving side thereof, and
wherein the optical filter causes visible light in an infrared range within the object light to not be transmitted therethrough.

4. An image-capturing apparatus comprising:
an image-capturing element having a group of first pixels configured to receive object light and generate an image signal representing an object image and a group of second pixels configured to receive the object light and generate a ranging signal for detecting a phase difference;
image obtaining means for obtaining a captured image on the basis of the image signal; and
focus detection means for performing focus detection on the basis of the ranging signal,
wherein the second pixels each include an optical filter on a light-receiving side thereof, and
wherein the optical filter causes visible light in a wavelength range wider than a wavelength range of visible light that is allowed by a green primary-color filter to be transmitted therethrough within the object light to be transmitted therethrough.

5. An image-capturing apparatus comprising:
an image-capturing element having a group of first pixels configured to receive object light and generate an image signal of an object image and a group of second pixels configured to receive the object light and generate a ranging signal for detecting a phase difference;
image obtaining means for obtaining a captured image on the basis of the image signal; and
focus detection means for performing focus detection on the basis of the ranging signal,
wherein the second pixels each include an optical filter on a light-receiving side thereof, and
wherein the optical filter causes visible light within the object light to not be transmitted therethrough.

6. An image-capturing apparatus comprising:
an image-capturing element having a group of first pixels configured to receive object light and generate an image signal representing an object image and a group of second pixels configured to receive the object light and generate a ranging signal for detecting a phase difference;
an image obtaining unit configured to obtain a captured image on the basis of the image signal; and
a focus detection unit configured to perform focus detection on the basis of the ranging signal,
wherein the second pixels each include an optical filter on a light-receiving side thereof, and
wherein the optical filter causes visible light in a wavelength range wider than a wavelength range of visible light that is allowed by a green primary-color filter to be transmitted therethrough within the object light to be transmitted therethrough.

7. An image-capturing apparatus comprising:
an image-capturing element having a group of first pixels configured to receive object light and generate an image signal of an object image and a group of second pixels configured to receive the object light and generate a ranging signal for detecting a phase difference;
an image obtaining unit configured to obtain a captured image on the basis of the image signal; and
a focus detection unit configured to perform focus detection on the basis of the ranging signal,
wherein the second pixels each include an optical filter on a light-receiving side thereof, and
wherein the optical filter causes visible light within the object light to not be transmitted therethrough.
